(19) United States
(12) Patent Application Publication
(10) Pub. No.: US 2026/0086489 A1
(43) Pub. Date: Mar. 26, 2026

(54) SHEET GUIDE DEVICE AND IMAGE FORMING APPARATUS

(71) Applicant: FUJIFILM Business Innovation Corp., Tokyo (JP)

(72) Inventors: Hiroaki AKAMATSU, Kanagawa (JP); Megumi MURAKAMI, Kanagawa (JP); Satoru ISHII, Kanagawa (JP)

(73) Assignee: FUJIFILM Business Innovation Corp., Tokyo (JP)

(21) Appl. No.: 19/066,498

(22) Filed: Feb. 28, 2025

(30) Foreign Application Priority Data
Sep. 24, 2024 (JP) 2024-165279

(51) Int. Cl. G03G 15/00

(52) U.S. Cl. CPC G03G 15/6558; G03G 2215/00409; G03G 2215/00565; G03G 2215/00683

(57) ABSTRACT

A sheet guide device includes a transport guide section that has a guide surface that, by allowing a sheet that is transported to pass, guides the sheet toward a transport destination; and an auxiliary member that is chargeable, that is attached to the guide surface, and that assists in guiding the sheet, in which the auxiliary member includes multiple narrow-width portions existing side by side in a width direction that intersects a transport direction of the sheet and each having a shape whose width becomes narrower in the transport direction.

### CROSS-REFERENCE TO RELATED APPLICATIONS

This application is based on and claims priority under 35 USC 119 from Japanese Patent Application No. 2024-165279 filed Sep. 24, 2024.

### BACKGROUND

### (i) Technical Field

The present disclosure relates to a sheet guide device and an image forming apparatus.

### (ii) Related Art

Japanese Unexamined Patent Application Publication No. 2021-54649 (claim 19, FIGS. 2 to 6 and FIG. 10) describes a recording-material guide device including a guide section that guides a recording material and a thin plate member that is provided at the guide section.

The guide section is a portion that guides a recording material as a result of being provided at a facing position where a first rotating body and a second rotating body face each other. The thin plate member is a plate-shaped member that is elastically deformed more easily than the guide section, and is a plate member that guides along a plate surface the recording material that is being transported. The thin plate member is a plate member that is thinner on a downstream side in a transport direction than on an upstream side in the transport direction.

In addition, Japanese Unexamined Patent Application Publication No. 2021-54649(claim 19, FIGS. 2 to 6 and FIG. 10) describes a recording-material guide device including a guide section that guides a recording material and a plate member that is provided at the guide section.

The plate member is a plate member extending downstream in the transport direction with decreasing distance to a center in a width direction that intersects the transport direction of the recording material, and having slits.

Japanese Unexamined Patent Application Publication No. 2000-172083 (claim 1, FIG. 1) describes an image forming apparatus including a guide member used for guiding to a transfer region.

The guide member is a member where a contact portion that contacts a transfer material and that is made of a conductive material is provided. The transfer region is a region between a toner image carrier and a transfer section.

The guide member is also a member where aluminum is vapor-deposited on a mylar surface.

Further, the guide member is also a carbon added mylar.

Japanese Unexamined Patent Application Publication No. 2006-208840 (claims 27 and 28, FIGS. 2 to 7) describes an image forming apparatus including, for example, a transport section, a first guide section, and a second guide section.

The transport section is a section that transports a transfer medium toward an image carrier.

The first guide section is a member that guides a transfer medium toward the image carrier, and has a flexible first guide surface, with a first base end portion side thereof being positionally fixed, and a first end portion of the first base end portion extending toward the image carrier.

The second guide section is a section that transports a transfer medium toward the image carrier.

The second guide section has a flexible second guide surface, with a second base end portion side thereof being positionally fixed and a second end portion of the second base end portion extending upstream in a transport direction and facing the first end portion.

Japanese Unexamined Patent Application Publication No. 2006-208840 (claims 27 and 28, FIGS. 2 to 7) also describes that at least one of the first guide section and the second guide section is formed from a film member.

### SUMMARY

Aspects of non-limiting embodiments of the present disclosure relate to a sheet guide device and an image forming apparatus including the sheet guide device, the sheet guide device being capable of suppressing a sheet that is being transported from sticking by static electricity to an auxiliary member that is chargeable, that is attached to a guide surface of a transport guide section, and that assists in guiding the sheet, compared to when the auxiliary member does not include multiple narrow-width portions each having a shape whose width becomes narrower in a transport direction of the sheet.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet guide device including a transport guide section that has a guide surface that, by allowing a sheet that is transported to pass, guides the sheet toward a transport destination; and an auxiliary member that is chargeable, that is attached to the guide surface, and that assists in guiding the sheet, in which the auxiliary member includes multiple narrow-width portions existing side by side in a width direction that intersects a transport direction of the sheet and each having a shape whose width becomes narrower in the transport direction.

### BRIEF DESCRIPTION OF THE DRAWINGS

Exemplary embodiments of the present disclosure will be described in detail based on the following figures, wherein:

FIG. 1 is a schematic view of an image forming apparatus including a sheet guide device according to a first exemplary embodiment;

FIG. 2 is a schematic view of the sheet guide device according to the first exemplary embodiment and the vicinity thereof;

FIG. 3 is an enlarged schematic view of the sheet guide device and the like in FIG. 2;

FIG. 4A is a schematic plan view of a first transport guide section and an auxiliary member including narrow-width portions, and FIG. 4B is a schematic sectional view along line IVB-IVB of FIG. 4A;

FIG. 5 is an enlarged plan view of the narrow-width portions;

FIG. 6 is an explanatory view showing a structure of each narrow-width portion in FIG. 5;

FIG. 7A is a front explanatory view showing an operation of the sheet guide device, and

FIG. 7B is a side explanatory view showing the operation of the sheet guide device;

FIG. 8 is a graph showing the results of an evaluation test;

FIG. 9 is a graph showing the results of a comparative test;

FIG. 10 is a schematic view of a reverse transport device including a sheet guide device according to a second exemplary embodiment;

FIG. 11 is a front schematic view of the sheet guide device according to the second exemplary embodiment and the vicinity thereof;

FIG. 12 is a side schematic view of the sheet guide device and the vicinity thereof in FIG. 11; and

FIG. 13A is a front explanatory view showing an earlier operation of the reverse transport device and the sheet guide device, and FIG. 13B is a front explanatory view showing an operation subsequent to the operation in FIG. 13A.

### DETAILED DESCRIPTION

Exemplary embodiments of the present disclosure are described below.

### First Exemplary Embodiment

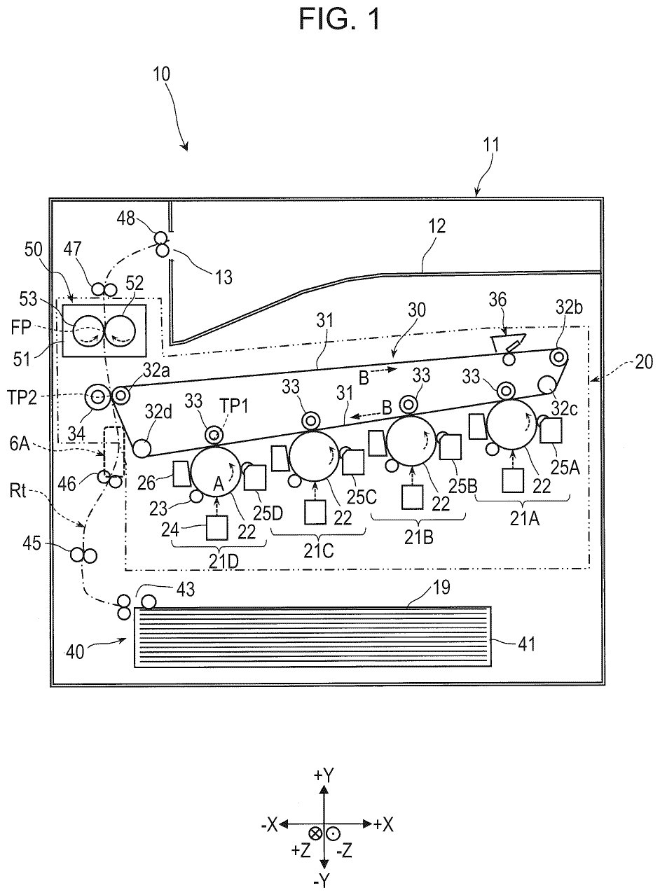

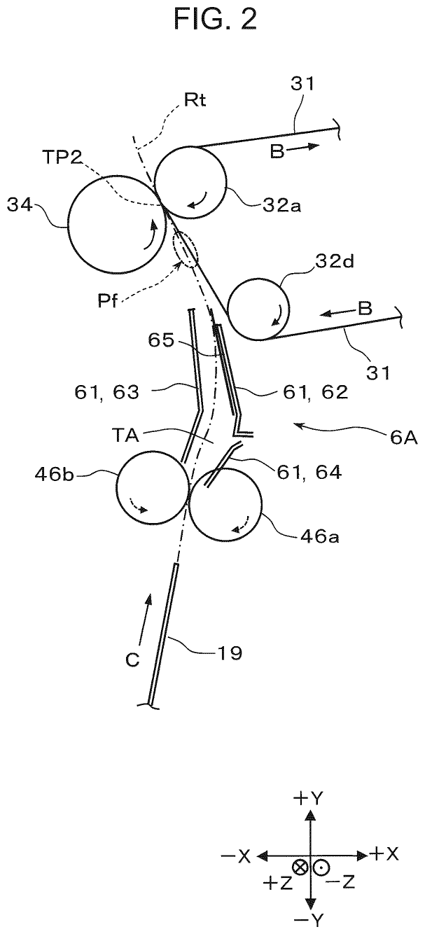

FIG. 1 illustrates an image forming apparatus 10 including a sheet guide device 6A according to a first exemplary embodiment. FIG. 2 illustrates the sheet guide device 6A according to the first exemplary embodiment.

In the specification and the drawings, structural elements that are substantially the same are given the same reference signs. In the specification, overlapping descriptions of the same structural elements are not given.

In FIG. 1 etc., arrow +X denotes a rightward direction when, for example, the image forming apparatus 10 is viewed from the front, and arrow −X denotes a leftward direction when, for example, the image forming apparatus 10 is viewed from the front. Arrow +Y denotes an upward direction with respect to, for example, the image forming apparatus 10, and arrow-Y denotes a downward direction with respect to, for example, the image forming apparatus 10. Further, reference sign +Z denotes a far-side direction when, for example, the image forming apparatus 10 is viewed from the front, and reference sign −Z denotes a near-side direction when, for example, the image forming apparatus 10 is viewed from the front.

A symbol in which a “circle” contains an “x” therein in FIG. 1 etc. denotes a direction from a near side toward a far side in a sheet plane of the drawings. A symbol in which a “circle” contains a “dot” therein denotes a direction from the far side toward the near side in the sheet plane of the drawings.

### Image Forming Apparatus

The image forming apparatus 10 is an apparatus that forms a predetermined image on a sheet 19.

An image is a representation of various pieces of information including, for example, characters, shapes, tables, and static images, which are visible on a sheet.

As shown in FIG. 1, in the image forming apparatus 10, for example, an image forming device 20 and a sheet supply device 40 are disposed in an internal space of a housing 11. In the image forming apparatus 10, the sheet guide device 6A is disposed in the housing 11.

Of these, the housing 11 is a box-shaped structural body having a predetermined external shape and the internal space.

The housing 11 includes, for example, a frame, a plate, and an exterior material.

The housing 11 is provided with a sheet-discharge accommodating section 12 on whose upper portion a sheet 19 having an image formed thereon is discharged and that accommodates the sheet 19. The housing 11 has a discharge port 13 for a sheet 19 in the vicinity of the sheet-discharge accommodating section 12.

The image forming device 20 of the first exemplary embodiment is constituted as a device that uses an image forming system such as an electrophotographic system.

The image forming device 20 includes four image forming units 21A, 21B, 21C, and 21D, an intermediate transfer unit 30, and a fixing unit 50.

The image forming units 21A, 21B, 21C, and 21D are each a unit that forms a toner image that is formed from a developer of a corresponding one of predetermined colors (A, B, C, and D) and that is unfixed. Examples of the predetermined colors (A, B, C, and D) include yellow, magenta, cyan, and black.

The image forming units 21A, 21B, 21C, and 21D each include a photoconductor drum 22 that is rotationally driven in the direction of arrow A.

A charging device 23, an exposure device 24, a developing device 25, a drum cleaning device 26, etc. are similarly disposed around each of the photoconductor drums 22.

Each charging device 23 is a device that charges an image formation surface of an outer peripheral surface of the photoconductor drum 22 to a predetermined surface potential.

Each exposure device 24 is a device that irradiates with light the charged image formation surface of the photoconductor drum 22 and forms an electrostatic latent image. The irradiation light is produced in correspondence with image information that is input from outside the image forming apparatus 10.

Each developing device 25 is a device that develops the electrostatic latent image on the photoconductor drum 22 with a developer (toner) of a predetermined color and forms a toner image.

In FIG. 1, the charging devices, the exposure devices, and the drum cleaning devices are labelled for only the image forming unit 21D as a representative with reference signs 23, 24, and 26, respectively. The developing devices 25 are indicated as developing devices 25A, 25B, 25C, and 25D in correspondence with the different colors (A, B, C, and D) of the developers that are used.

The intermediate transfer unit 30 is a unit that transfers onto a sheet 19 the toner images formed by the respective image forming units 21A, 21B, 21C, and 21D of the image forming device 20.

The intermediate transfer unit 30 includes, for example, an intermediate transfer belt 31, first transfer devices 33, a second transfer device 34, and a belt cleaning device 36.

The intermediate transfer belt 31 is an endless belt that is capable of holding the toner images substantially by static electricity on an outer peripheral surface of the belt and transporting the toner images.

The intermediate transfer belt 31 rotates by passing the photoconductor drums 22 of the respective image forming units 21A, 21B, 21C, and 21D. The intermediate transfer belt 31 is placed on a predetermined number of rollers, that is, support rollers 32a, 32b, 32c, and 32d, and rotates in the direction of arrow B.

Of these, the support roller 32a is constituted as, for example, a drive roller and a second-transfer back roller. The support roller 32b is constituted as a belt running adjustment roller that adjusts a running state of the intermediate transfer belt 31. The support rollers 32c and 32d are constituted as surface rollers that form a first transfer surface in the intermediate transfer belt 31.

Each first transfer device 33 is a device that first-transfers the toner image formed on the corresponding photoconductor drum 22 to the outer peripheral surface of the intermediate transfer belt 31.

The second transfer device 34 is a device that second-transfers the toner images first-transferred to the outer peripheral surface of the intermediate transfer belt 31 to one surface of a sheet 19.

Reference sign TP1 in FIG. 1 denotes a first transfer position where one of the first transfer devices 33 faces the corresponding photoconductor drum 22 with the intermediate transfer belt 31 interposed therebetween. Reference sign TP2 in FIG. 1 denotes a second transfer position where the second transfer device 34 faces the support roller 32a with the intermediate transfer belt 31 interposed therebetween.

The sheet supply device 40 is a device that accommodates predetermined sheets 19 and supplies the predetermined sheets 19 to the image forming device 20.

The sheet supply device 40 includes, for example, an accommodating body 41 that accommodates sheets 19 and a send-out device 43 that sends out the sheets 19 from the accommodating body 41 one sheet at a time. The sheet supply device 40 may include multiple sets of the accommodating body 41 and the send-out device 43.

The sheets 19 are recording media that are transported in the housing 11, and that, for example, allow toner images to be transferred thereon at the image forming device 20. As the sheets 19, sheet-like materials that have been cut to a predetermined size are primarily used. The sheets 19 are not limited to sheets made of pulp. The sheets 19 may be, for example, coated paper coated with a resin material.

The fixing unit 50 is a unit that fixes to a sheet 19 toner images that are formed on a sheet 19 at the image forming device 20.

The fixing unit 50 is constituted by disposing, for example, a heating rotating body 52 and a pressing rotating body 53 in a fixing housing 51. The heating rotating body 52 and the pressing rotating body 53 are each a rotating body having the form of a roller or a belt. The heating rotating body 52 and the pressing rotating body 53 contact each other under pressure and rotate in the direction of a dashed arrow.

In the fixing unit 50, a contact portion where the heating rotating body 52 and the pressing rotating body 53 contact each other becomes a fixing nip where a fixing operation is performed by causing a sheet 19 to pass the contact portion. The fixing nip also becomes a fixing position FP.

A sheet transport path Rt that is exemplified by an alternate long and short dash line in FIG. 1 is provided in the housing 11.

The sheet transport path Rt includes a transport path extending from the sheet supply device 40 to the discharge port 13 via the intermediate transfer unit 30 and the fixing unit 50.

The sheet transport path Rt is formed by, for example, a predetermined number of transport rollers, that is, two transport rollers 45, two transport rollers 46, two transport rollers 47, and two transport rollers 48, and a transport guide member (not shown). As a part of the transport guide member, a transport guide section 61 (described below) (see, for example, FIG. 2) of the sheet guide device 6A is disposed.

Of these, the two transport rollers 46 are adjustment rollers that, after temporarily stopping a sheet 19, send out the sheet 19 in accordance with when a second transfer operation is performed. The adjustment rollers are also called registration rollers. The two transport rollers 46 are constituted by causing a drive roller 46a and a driven roller 46b to contact each other.

The sheet guide device 6A that guides to the second transfer position TP2 a sheet 19 that has been sent out from the two transport rollers 46 is disposed at the sheet transport path Rt.

The details of the sheet guide device 6A are described below.

### Image Forming Operation

An image is formed by the image forming apparatus 10 as follows.

Here, a case in which all of the image forming units 21A, 21B, 21C, and 21D of the image forming device 20 form toner images is considered.

In the image forming apparatus 10, when a controller (not shown) receives an instruction for an image forming operation, the image forming device 20, the sheet supply device 40, and the like start to operate.

At this time, at the image forming device 20, the photoconductor drums 22 of the respective image forming units 21A, 21B, 21C, and 21D start to rotate in the directions of arrows A. With respect to the photoconductor drums 22 that rotate, a charging operation, an exposure operation, a developing operation, a transfer operation, and a cleaning operation are performed.

In addition, at this time, at the image forming device 20, the intermediate transfer belt 31 of the intermediate transfer unit 30 starts to rotate in the direction of arrow B. At the intermediate transfer unit 30, a first transfer operation, a second transfer operation, and a cleaning operation are performed.

Further, at this time, at the sheet supply device 40 and the sheet transport path Rt, a sheet-feed operation is performed in accordance with the timing of the second transfer operation.

As a result, at the image forming device 20, after toner images of colors corresponding to the respective photoconductor drums 22 are formed, the toner images are first-transferred to the intermediate transfer belt 31 and are transported up to the second transfer position TP2.

On the other hand, at the image forming device 20, a predetermined sheet 19 is sent out from the sheet supply device 40 and is supplied to the second transfer position TP 2 via the sheet transport path Rt.

At this time, the sheet 19 that has been sent out by the two transport rollers 46 is transported to the second transfer position TP2 via the sheet guide device 6A.

At the image forming device 20, the toner images are second-transferred to the sheet 19 from the intermediate transfer belt 31 at the second transfer position TP2.

When the image forming device 20 receives the instruction for the image forming operation, the fixing unit 50 starts to operate completely. At the fixing unit 50 at this time, the heating rotating body 52 and the pressing rotating body 53 start to rotate. In addition, at the fixing unit 50 at this time, the heating rotating body 52 starts to be heated until a temperature at which fixing can be performed is reached.

Then, at the fixing unit 50, after a temperature state in which the fixing operation can be performed is maintained, the fixing operation is performed.

As a result, at the image forming device 20, the sheet 19 to which the toner images have been second-transferred is introduced and passes the fixing nip of the fixing unit 50.

At this time, the toner on the sheet 19 when passing the fixing nip is heated under pressure, is melted, and is fixed to the sheet 19.

Finally, at the image forming apparatus 10, the sheet 19 after the fixing is transported from the fixing unit 50 to the discharge port 13 for the sheet via the sheet transport path Rt.

At this time, the sheet 19 after the fixing is discharged from the discharge port 13 by the transport rollers 48 and is accommodated at the sheet-discharge accommodating section 12.

By the series of operation above, the image forming operation of forming the images of the predetermined colors (A, B, C, and D) on one surface of the sheet 19 is ended.

### Sheet Guide Device

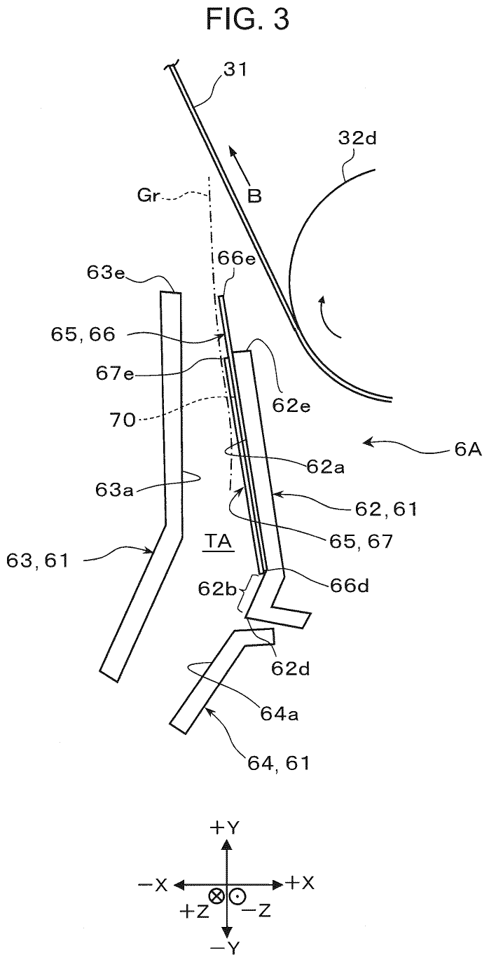

As shown in FIGS. 2 and 3, the sheet guide device 6A includes at least the transport guide section 61 and an auxiliary member 65.

The sheet guide device 6A of the first exemplary embodiment constitutes a part of the sheet transport path Rt. In addition, the sheet guide device 6A is disposed between the two transport rollers 46 and the second transfer position TP2.

The transport guide section 61 is a member having a guide surface that, by allowing a sheet 19 that is transported to pass, guides the sheet 19 toward a transport destination.

The transport guide section 61 of the first exemplary embodiment includes a first guide member 62, a second guide member 63, and a third guide member 64.

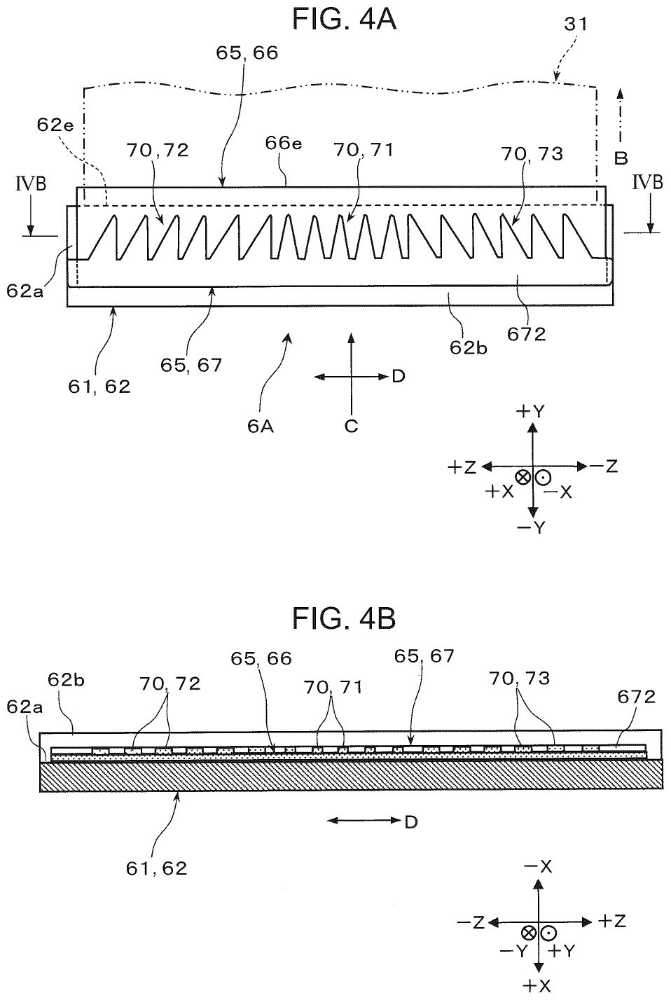

The first guide member 62 is a plate-shaped member whose planar shape is a rectangular shape and that has a predetermined thickness. The rectangular shape of the planar shape is a substantially rectangular shape that is long along a width direction D that intersects a transport direction C of a sheet 19 (see FIG. 4A).

The first guide member 62 is disposed from a position where a sheet has passed the two transport rollers 46 to a position close to the intermediate transfer belt 31. The position close to the intermediate transfer belt 31 is a position where the first guide member 62 faces at a predetermined angle and at a predetermined interval therefrom a portion of the intermediate transfer belt 31 that is supported by the support roller 32d.

The third guide member 64 is disposed so as to exist between the two transport rollers 46 and an upstream end 62d of the first guide member 62. The upstream end 62d is an end of the first guide member 62 on an upstream side in the transport direction C of a sheet 19.

The second guide member 63 is disposed so as to face the first guide member 62 and the third guide member 64 at a predetermined interval therefrom.

Therefore, the second guide member 63 forms between it and the first guide member 62 and the third guide member 64 a transport space TA where a sheet 19 passes.

The transport space TA is a space whose gap is gradually narrowed toward a downstream side in the transport direction C of a sheet 19.

The first guide member 62 has a guide surface 62a that is capable of guiding a sheet 19 toward a side opposite to the intermediate transfer belt 31.

Although the guide surface 62a is a substantially planar surface, the guide surface 62a is provided with a bent surface 62b on an upstream side in the transport direction C of a sheet 19. The bent surface 62b is a plane that is bent at a predetermined angle in a direction toward the second guide member 63.

Further, the second guide member 63 and the third guide member 64 also have a guide surface 63a and a guide surface 64a, respectively.

The guide surface 63a has a surface shape that bends at a predetermined angle in a direction away from the first guide member 62. The guide surface 64a has a surface shape that is substantially continuous with the bent surface 62b of the guide surface 62a.

The guide surfaces 63a and 64a each have multiple projections extending parallel in a straight line along the transport direction C of a sheet 19 on a plane. The projections are also called ribs.

In the exemplary embodiment, the first guide member 62 is made of a metal material.

The second guide member 63 and the third guide member 64 are each made of a resin material. Although the second guide member 63 and the third guide member 64 are independent special-purpose members, they may be formed at a part of another structural member.

The auxiliary member 65 is a member that is attached to the guide surface 62a of the first guide member 62 serving as the transport guide section 61, and assists in guiding a sheet 19.

The auxiliary member 65 is a member that is chargeable. Chargeable refers to a physical property allowing something to be charged by an external cause. An example of the external cause is passage of a charged sheet 19 in contact with or close to the auxiliary member 65.

Further, as shown in, for example, FIGS. 4A and 4B, the auxiliary member 65 has multiple narrow-width portions 70.

Each narrow-width portion 70 is a portion having a shape whose width becomes narrower in the transport direction C of a sheet 19. In addition, the narrow-width portions 70 are portions existing side by side in the width direction D that intersects the transport direction C of a sheet 19.

The width of each narrow-width portion 70 is a dimension along the width direction D.

As shown in FIGS. 3 and 4A and 4B, the auxiliary member 65 of the first exemplary embodiment includes a first auxiliary member 66 and a second auxiliary member 67.

The first auxiliary member 66 is an auxiliary member that is attached to the guide surface 62a of the first guide member 62.

As the first auxiliary member 66 of the first exemplary embodiment, a synthetic resin film or a synthetic resin sheet is used.

Here, the film has, for example, the form of a thin film having a thickness that is less than 250 μ. The sheet has, for example, the form of a thin film having a thickness that is greater than or equal to 250 μ.

Examples of synthetic resin include polypropylene (PP), polyacetal resin (POM), and polyethylene terephthalate (PET).

The first auxiliary member 66 of the first exemplary embodiment is constituted as a member whose planar shape is a substantially rectangular shape and that has a predetermined thickness.

The first auxiliary member 66 is attached, by a fixer, such as a double-sided tape, to substantially the whole surface of the guide surface 62a excluding the bent surface 62b.

The first auxiliary member 66 is attached with a downstream end 66e thereof being in a projecting state from the downstream end 62e of the first guide member 62.

The downstream end 66e of the first auxiliary member 66 is an end on the downstream side in the transport direction C of a sheet 19. The downstream end 66e of the first auxiliary member 66 projects up to a position where the downstream end 66e substantially faces a downstream end 63e of the second guide member 63.

The first auxiliary member 66 is situated at a position where an upstream end 66d thereof reaches a boundary between it and the bent surface 62b of the guide surface 62a.

The second auxiliary member 67 is an auxiliary member that is attached on a side of the first auxiliary member 66 opposite to the guide surface 62a and that includes the narrow-width portions 70.

As the second auxiliary member 67 of the first exemplary embodiment, similarly to the first auxiliary member 66, a synthetic resin film or a synthetic resin sheet is used.

Examples of synthetic resin include polypropylene (PP) and polyacetal resin (POM).

The second auxiliary member 67 of the first exemplary embodiment is constituted as a member including a foundation portion 672 and the narrow-width portions 70 and having a predetermined thickness.

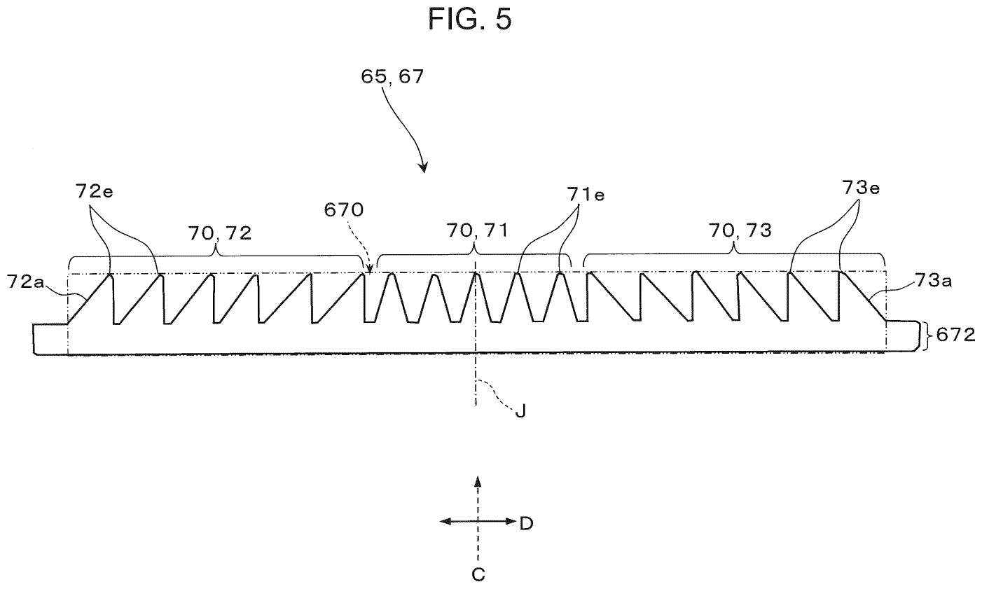

As shown in FIGS. 4A and 4B and 5, the foundation portion 672 is a portion whose planar shape is a substantially rectangular shape and that has a predetermined thickness. The foundation portion 672 is used by being attached with a longitudinal direction thereof being along the width direction D.

The narrow-width portions 70 are portions constituted as multiple narrow-width portions 71, 72, and 73 whose planar shapes are triangular shapes.

The narrow-width portions 71, 72, and 73 are provided so as to exist side by side along one of the long sides of the foundation portion 672 (see, for example, FIG. 5). The narrow-width portions 71, 72, and 73 are each formed to have a thickness that is the same as the thickness of the foundation portion 672.

Each narrow-width portion 71 is a narrow-width portion that is disposed in, of a region where a sheet 19 that is being transported can pass, a central region in the width direction D.

The narrow-width portions 71 are formed in a state in which multiple narrow-width portions exist side by side in the width direction D. The narrow-width portions 71 of the first exemplary embodiment are disposed such that five narrow-width portions 71 are disposed side by side in the width direction D.

The narrow-width portions 72 and 73 are narrow-width portions that are disposed at, of the region where a sheet 19 that is being transported can pass, a corresponding one of end portion regions on two sides of the central region in the width direction D.

The narrow-width portions 72 and 73 are formed in a state in which multiple narrow-width portions exist side by side in the width direction D. The narrow-width portions 72 and 73 of the first exemplary embodiment are disposed such that six narrow-width portions 72 and six narrow-width portions 73 are disposed side by side in the width direction D.

The number and the positions of the narrow-width portions 72 and the number and the positions of the narrow-width portions 73 are substantially selected in correspondence with the width W of a sheet 19 that is to be transported.

The narrow-width portions 71, 72, and 73 are such that downstream ends 71e, 72e, and 73e thereof in the transport direction C of a sheet 19 are aligned with respect to each other in the width direction D (see FIG. 5). The downstream ends 71e, 72e, and 73e are subjected to round surface processing (chamfering).

The second auxiliary member 67 is attached in a state in which the second auxiliary member 67 is displaced upstream in the transport direction C of a sheet 19 with respect to the first auxiliary member 66.

Specifically, the downstream ends 71e, 72e, and 73e of the respective narrow-width portions 71, 72, and 73 are displaced upstream in the transport direction C of a sheet 19 with respect to the downstream end 66e of the first auxiliary member 66.

The second auxiliary member 67 is attached in a state in which the second auxiliary member 67 exists along substantially the whole guide surface 62a excluding the bent surface 62b of the first guide member 62.

In other words, the downstream ends 71e, 72e, and 73e of the respective narrow-width portions 71, 72, and 73 are substantially aligned in the transport direction C with respect to the downstream end 62e of the first guide member 62.

The foundation portion 672 is in a state in which the foundation portion 672 reaches the bent surface 62b.

Further, the second auxiliary member 67 is attached, by a fixer, such as a double-sided tape, to the first auxiliary member 66.

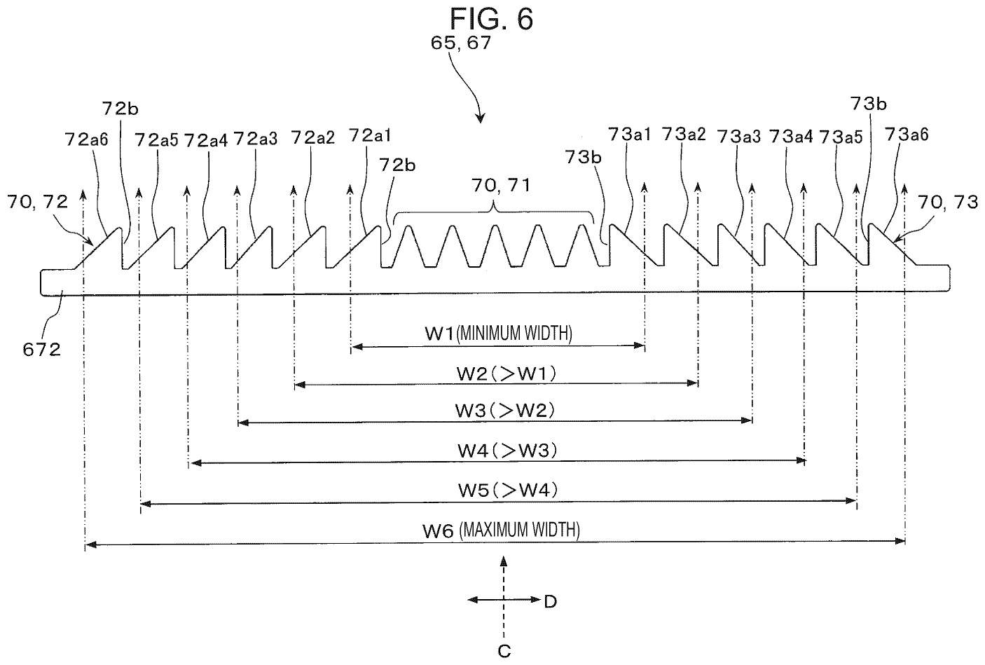

Some of the narrow-width portions 70 have a linear oblique side that intersects a passage expected position of at least one of two ends, that is, a left end 19c and a right end 19d, of a sheet 19 that is being transported (see FIG. 6). Alternate long and two short dash line arrows in FIG. 6 denote design paths (positions) where the left end 19c and the right end 19d of the sheet 19 pass.

In the first exemplary embodiment, the narrow-width portions 72 are narrow-width portions having linear oblique sides 72a and the narrow-width portions 73 are narrow-width portions having linear oblique sides 73a, the oblique sides 72a and 73a being where the left end 19c and the right end 19d of a sheet 19 pass.

Here, the sheet transport path Rt of the first exemplary embodiment uses a center registration transport system. The center registration transport system is a system in which a sheet 19 is transported with the center in the width direction D of the sheet 19 that is being transported being aligned with a central position of the sheet transport path Rt in the width direction D.

The sheet transport path Rt of the image forming apparatus 10 is assumed to be capable of transporting, for example, sheets 19 having six types of widths W1 to W6.

Reference signs W1 to W6 in FIG. 6 denote six types of widths.

The narrow-width portions 72 and 73 that are disposed at positions closest to the center have respective oblique sides 72a1 and 73a1 where left and right ends of a sheet 19 having a minimum width W1 are expected to pass.

The narrow-width portions 72 and 73 that are disposed at positions that are the second closest to the center have respective oblique sides 72a2 and 73a2 where left and right ends of a sheet 19 having a width W2 that is the next widest width in relation to the smallest width W1 are expected to pass.

The narrow-width portions 72 and 73 that are disposed at positions that are the third closest to the center have respective oblique sides 72a3 and 73a3 where left and right ends of a sheet 19 having a width W3 that is the next widest width in relation to the width W2 are expected to pass.

The narrow-width portions 72 and 73 that are disposed at positions that are the fourth closest to the center have respective oblique sides 72a4 and 73a4 where left and right ends of a sheet 19 having a width W4 that is the next widest width in relation to the width W3 are expected to pass.

The narrow-width portions 72 and 73 that are disposed at positions that are the fifth closest to the center have respective oblique sides 72a5 and 73a5 where left and right ends of a sheet 19 having a width W5 that is the next widest width in relation to the width W4 are expected to pass.

The narrow-width portions 72 and 73 that are disposed at positions at two outermost sides have respective oblique sides 72a6 and 73a6 where left and right ends of a sheet 19 having a maximum width W6 are expected to pass.

Narrow-width portions 72 and 73 of a second exemplary embodiment are such that respective oblique sides 72a and 73a are oblique sides that are inclined so as to face a central side in the width direction D with respect to the transport direction C.

The narrow-width portions 72 and 73 are disposed such that the oblique sides 72a and 73a exist in a line-symmetry relationship in the width direction D (see FIG. 5). An alternate long and short dash line J in FIG. 5 denotes a linear axis indicating the line symmetry.

The linear axis J substantially coincides with the central position in the width direction D of the sheet transport path Rt in the center registration transport system.

Even the narrow-width portions 71 at the central region in the first exemplary embodiment are disposed so as to exist in a line-symmetry relationship in the width direction D.

Further, the narrow-width portions 72 and 73 have shapes including respective parallel sides 72b and 73b parallel to the transport direction C on a side opposite to the respective oblique sides 72a and 73a.

The narrow-width portions 72 and 73 are constituted as narrow-width portions whose planar shapes are right-angled triangular shapes in which the width direction D defines a base. However, the narrow-width portions 72 and 73 differ from each other in that their respective oblique sides 72a and 73a are inclined in different directions (see FIG. 6).

The narrow-width portions 71 are constituted as narrow-width portions whose planar shapes are isosceles triangular shapes in which the width direction D defines a base. The isosceles triangular shapes include equilateral triangular shapes.

The sheet guide device 6A is capable of guiding a sheet 19 that is transported in the transport space TA so as to move forward in a transport path Gr that is exemplified by an alternate long and short dash line in FIG. 3.

That is, when a sheet 19 moves along the guide surface 62a of the first guide member 62 of the transport guide section 61, the sheet guide device 6A guides the sheet 19 by allowing the sheet 19 to contact the auxiliary member 65.

### Operation of Sheet Guide Device

When a sheet 19 is send out and transported from the two transport rollers 46, the sheet guide device 6A guides the sheet 19 that is being transported.

At this time, the guide surface 64a of the third guide member 64, the guide surface 62a of the first guide member 62, and the guide surface 63a of the second guide member 63 regulate a movement range of the sheet 19.

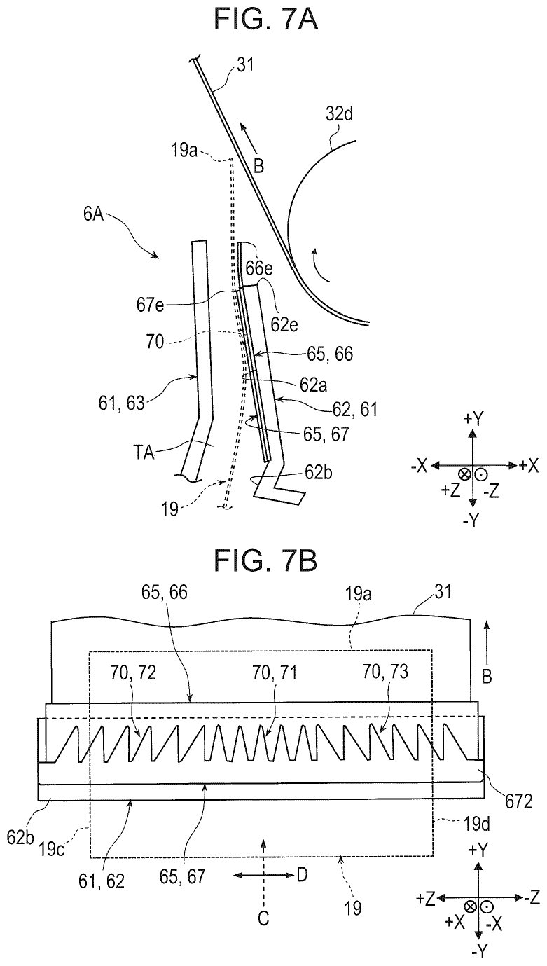

Therefore, the sheet 19 moves in the transport space TA that is formed by the first guide member 62, the second guide member 63, and the third guide member 64 of the transport guide section 61. That is, the sheet 19 moves and is transported in the transport space TA as exemplified by a broken line in FIG. 7A.

As a result, the sheet 19 is guided so as to pass the inside of the transport space TA and is guided toward the second transfer position TP2 that is a transport destination.

The sheet guide device 6A guides the sheet 19 such that the sheet 19 starts contacting the outer peripheral surface of the intermediate transfer belt 31 at a position Pf before the second transfer position TP2. The position Pf is a position where the sheet 19 reaches just before reaching the second transfer position TP2 as exemplified by a broken-line ellipse in FIG. 2.

Incidentally, the second transfer position TP2 that is a transport destination can be said to be a position where an image is formed on the sheet 19. Strictly speaking, the second transfer position TP2 is a position where an unfixed image, which becomes the source of the image, is formed on the sheet 19.

The sheet guide device 6A guides the sheet 19 that is transported along the guide surface 62a of the first guide member 62 by causing the sheet 19 to contact the auxiliary member 65.

At this time, the auxiliary member 65 is such that, first, the second auxiliary member 67 including the narrow-width portions 70 contacts the sheet 19. Next, a part of the first auxiliary member 66 contacts the sheet 19. The part of the first auxiliary member 66 is at least a part of a portion of the first auxiliary member 66 that is exposed below the second auxiliary member 67.

Therefore, after the sheet 19 has moved by contacting the second auxiliary member 67 including the narrow-width portions 70, the sheet 19 moves by contacting the part of the first auxiliary member 66. In particular, the sheet 19 moves by first contacting at least a part of the narrow-width portions 70 of the second auxiliary member 67.

As a result, before the sheet 19 contacts the part of the first auxiliary member 66, the sheet 19 moves by contacting the second auxiliary member 67 including the narrow-width portions 70.

In the sheet guide device 6A, the sheet 19 that has passed the second auxiliary member 67 passes by contacting the part of the first auxiliary member 66.

The part of the first auxiliary member 66 at this time is elastically flexed as a result of a portion that is not supported by the first guide member 62 contacting the sheet 19. The flexing corresponds to deformation of the downstream end 66e of the first auxiliary member 66 so as to approach the intermediate transfer belt 31.

As a result, the sheet 19 is guided such that a front end 19a thereof in the transport direction C slowly approaches and contacts the outer peripheral surface of the intermediate transfer belt 31.

The sheet guide device 6A is such that the narrow-width portions 72 and 73, which are some of the narrow-width portions 70, have the respective linear oblique sides 72a and 73a.

### Evaluation Test

Next, an evaluation test performed with regard to the sheet guide device 6A is described.

In the evaluation test, in the image forming apparatus 10, a sheet 19 was continuously transported so as to pass sheet guide devices whose auxiliary members 65 had different structures. In the evaluation test, a surface potential of each of the auxiliary members 65 at this time and occurrence of non-occurrence of a jam were examined.

As the sheet guide devices, those in which the auxiliary members 65 having various structures were individually attached to guide surfaces 62a of respective first guide members 62 were prepared.

One of the sheet guide devices is a sheet guide device (example) using the auxiliary member 65 including the narrow-width portions 70 above and made of PP (half the area). “Half the area” means that, when the narrow-width portions 70 are a remaining portion after cutting a part of an original member whose planar shape is a square shape, the plane area of the auxiliary member 65 is an area that is half the plane area of the original member.

Another one of the sheet guide devices is a sheet guide device (Comparative Example 1) using the auxiliary member 65 not including the narrow-width portions 70 above and made of PET (whole area). The “whole area” means an area that is the equal to the plane area of the original member. In the evaluation test, the whole area is approximately 9000 mm².

Still another one of the sheet guide devices is the sheet guide device (Comparative Example 2) using the auxiliary member 65 not including the narrow-width portions 70 above and made of PP (whole area).

Still another one of the sheet guide devices is the sheet guide device (Reference Example) using the auxiliary member 65 including the narrow-width portions 70 above and made of PET (half the area).

The image forming apparatus 10 was operated under an environment of 28° C. and 85% RH and at a process speed of 70 ppm (pages/minute).

As sheets 19, A3-size ordinary sheets (manufactured by Oji Paper Co., Ltd.: recycled PPC paper) were used.

Surface potentials of the auxiliary members 65 were periodically measured at the time of passage of a predetermined number of sheets. The surface potentials were measured by using a static electricity measuring instrument (manufactured by Simco Company, Inc.: FNX-004).

Occurrence and non-occurrence of a jam were examined when A4-size ordinary sheets passed at the time the surface potentials of the auxiliary members 65 were measured. The A4-size ordinary sheets are ordinary sheets having a moisture content of approximately 8% (manufactured by Oji Paper Co., Ltd.: recycled PPC paper, and manufactured by FUJIFILM Business Innovation Corp.: C2).

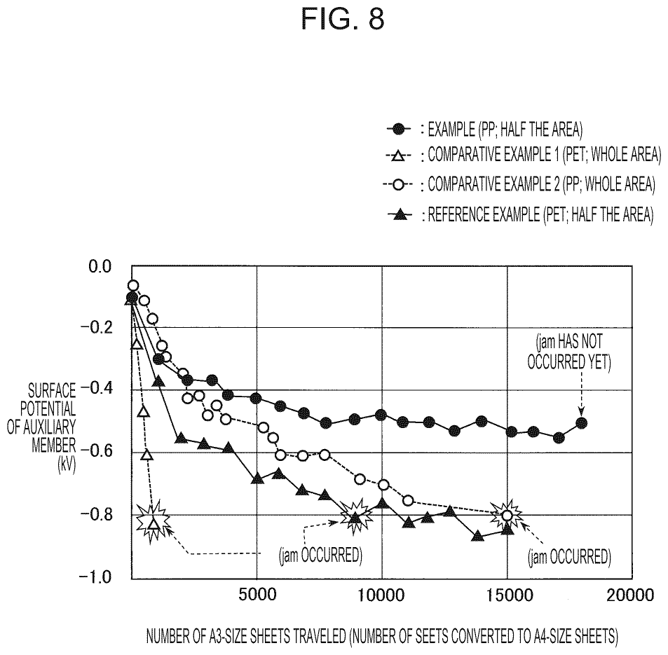

The results of the evaluation test are shown in FIG. 8.

In the Example, a jam did not occur even when about 18000 sheets 19 (=1.8 kV) passed.

In Comparative Example 1, a jam occurred when a few number of (about 1000) sheets 19 passed.

In Comparative Example 2, a jam occurred when about 15000 sheets 19 (=1.5 kV) passed.

Incidentally, in the Reference Example, a jam occurred when about 9000 sheets 19 (=0.9 kV) passed.

### Comparative Test

Next, a comparative test performed in relation to the auxiliary member 65 of the sheet guide device 6A is described.

In the comparative test, sheets 19 were continuously transported to sheet guide devices including, as auxiliary members 65, those whose plane areas were changed for using, for example, three types of sheets. In the comparative test, the surface potentials of the auxiliary members 65 at this time were periodically examined as in the evaluation test.

As the auxiliary members 65, those made of three types of materials, one being made of PET, one being made of PP, and one being made of POM, were used.

The plane area of the original member of each of the auxiliary members 65 had a maximum area of approximately 9000 mm².

The plane area of each of the auxiliary members 65 was changed in accordance with the wideness and narrowness of the plane area of the narrow-width portions 70.

The surface electricity was measured after transporting 18000 A4-size ordinary sheets (recycled PPC paper, C2) (=1.8 kV) as the sheets 19.

The test environment was the same as that of the evaluation test above.

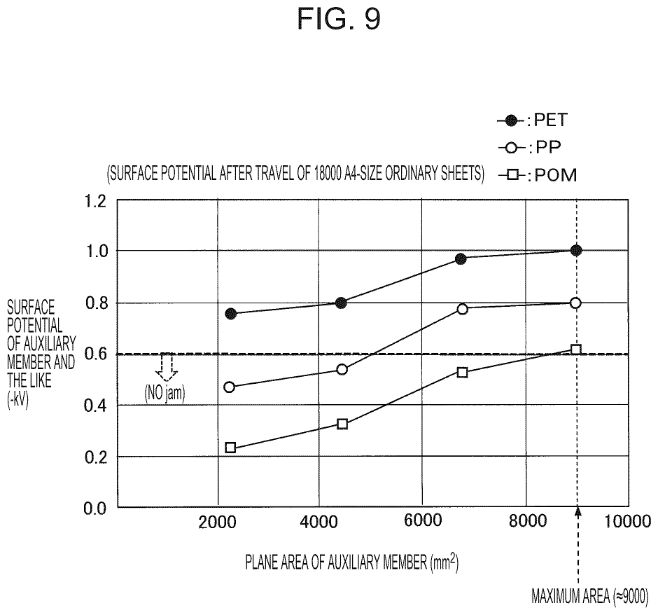

The results of the comparative test are shown in FIG. 9.

In the results of the comparative test, an evaluation index in which a jam does not occur when the surface electricity is less than or equal to −0.6 kV was set.

As a result, it was found that, when the auxiliary member 65 made of PP had narrow-width portions 70 where the plane area became an area less than or equal to half the maximum area, it was possible to avoid a jam. The plane area that is less than or equal to half the maximum area is an area that is less than or equal to approximately 4500 mm².

On the other hand, it was found that, when the auxiliary member 65 made of PET was such that the plane area was a narrow area of about ¼ of the maximum area, it was difficult to avoid a jam.

### Structure of Auxiliary Member

The sheet guide device 6A uses as, the second auxiliary member 67 including the narrow-width portions 70, a member that is less likely to be charged than the first auxiliary member 66. The member that is less likely to be charged is, for example, a member whose triboelectric series is positioned on a side that is relatively unlikely to be charged.

Specifically, when a PET member is used as the first auxiliary member 66, a PP member is used as the second auxiliary member 67.

When the narrow-width portions 70 are a remaining portion after cutting a part of an original member 670 where the planar shapes of the narrow-width portions 70 are square shapes, the sheet guide device 6A uses the following structure. The original member 670 is a rectangular member that surrounds the narrow-width portions 70 exemplified by an alternate long and two short dash line in FIG. 5, including a portion of the foundation portion 672 where the narrow-width portions 70 exist.

The “following structure” refers to a structure in which the plane area of the narrow-width portions 70 is an area that is less than equal to half the plane area of the original member 670. The plane area of the narrow-width portions 70 of the first exemplary embodiment is the total of the plane area of the narrow-width portions 70 and the plane area of the foundation portion 672.

### Second Exemplary Embodiment

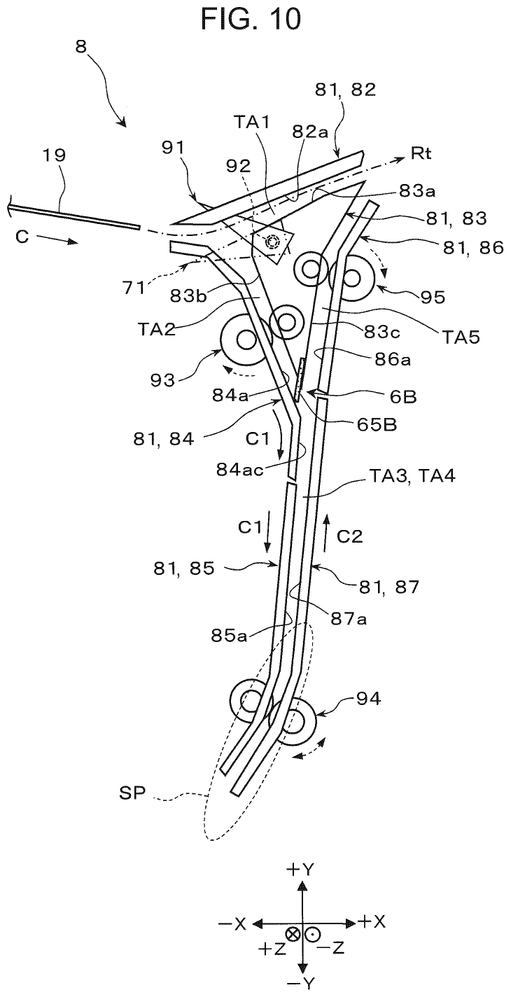

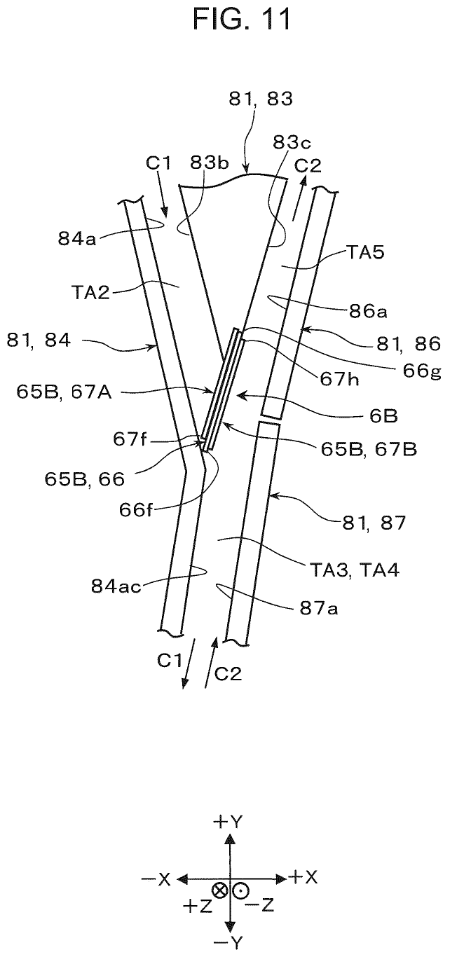

FIG. 10 illustrates a reverse transport device 8 to which a sheet guide device 6B according to a second exemplary embodiment is applied. FIG. 11 is an enlarged view of the sheet guide device 6B in FIG. 10.

The reverse transport device 8 transports a sheet 19 that is transported in an ordinary sheet transport path Rt so as to reverse front and back surfaces of the sheet 19 and move the sheet 19 into the sheet transport path Rt.

The reverse transport device 8 includes the following six guide members as transport guide sections 81. The transport guide sections 81 are a first guide member 82, a second guide member 83, a third guide member 84, a fourth guide member 85, a fifth guide member 86, and a sixth guide member 87.

The first guide member 82 is a guide member having a guide surface 82a that forms the ordinary sheet transport path Rt.

The first guide member 82 is such that the guide surface 82a is a lower surface, and is disposed in an inclined state such that the transport direction C of a sheet 19 becomes an upward movement direction.

The second guide member 83 is a guide member having a first guide surface 83a, a second guide surface 83b, and a third guide surface 83c.

The second guide member 83 is, for example, a member whose shape has three sides. The three sides of the second guide member 83 are formed as the first guide surface 83a, the second guide surface 83b, and the third guide surface 83c.

The second guide member 83 is disposed in a state in which its upper side is the first guide surface 83a and the two sides that merge at a lower side become the second guide surface 83b and the third guide surface 83c. The second guide member 83 is disposed below the first guide member 82. The second guide member 83 is disposed in a state in which the first guide surface 83a faces the guide surface 82a of the first guide member 82 with a predetermined interval therebetween.

The third guide member 84 is a guide member having a guide surface 84a.

The third guide member 84 is disposed on a side where the second guide surface 83b of the second guide member 83 exists. The third guide member 84 is disposed in a state in which an intermediate portion of the guide surface 84a faces the second guide surface 83b of the second guide member 83 with a predetermined interval therebetween.

The guide surface 84a includes at its lower portion a bent guide portion 84ac. The bent guide portion 84ac is formed as a surface that can face substantially parallel to an upper portion of a guide surface 87a of the sixth guide member 87 described below.

The fourth guide member 85 is a guide member having a guide surface 85a.

The fourth guide member 85 is disposed below the third guide member 84 and in a state of connection with a lower end of the third guide member 84.

The fifth guide member 86 is a guide member having a guide surface 86a.

The fifth guide member 86 is disposed on a side where the third guide surface 83c of the second guide member 83 exists. The fifth guide member 86 is disposed in a state in which the guide surface 86a faces the third guide surface 83c of the second guide member 83 with a predetermined interval therebetween.

The sixth guide member 87 is a guide member having the guide surface 87a.

The sixth guide member 87 is disposed below the fifth guide member 86 and in a state of connection with a lower end of the fifth guide member 86. The sixth guide member 87 is disposed in a state in which the upper portion of the guide surface 87a faces the lower portion of the guide surface 84a of the third guide member 84 with a predetermined interval therebetween. The lower portion of the guide surface 84a is the guide portion 84ac formed by bending the guide surface 84a. The sixth guide member 87 is disposed in a state in which a lower portion of the guide surface 87a faces the guide surface 85a of the fourth guide member 85 with a predetermined interval therebetween.

The reverse transport device 8 has transport spaces TA1, TA2, TA3, TA4, and TA5.

The transport space TA1 is an ordinary-transport transport space. The transport space TA1 is formed between the guide surface 82a of the first guide member 82, the first guide surface 83a of the second guide member 83, and an upper portion of the guide surface 84a of the third guide member 84. The transport space TA1 forms the ordinary sheet transport path Rt.

The transport space TA2 is a branching-introduction transport space. The transport space TA2 is formed between the second guide surface 83b of the second guide member 83 and the guide surface 84a of the third guide member 84.

The transport space TA3 is a lead-in transport space. The transport space TA3 is formed between a lower portion of the guide surface 85a of the fourth guide member 85, the guide surface 86a of the fifth guide member 86, and the guide surface 87a of the sixth guide member 87.

The transport space TA4 is a turnaround-transport transport space. The transport space TA4 is a transport space that is the same as the transport space TA3, and is also a transport space that is used as the transport space TA3.

The transport space TA5 is a merging transport space. The transport space TA5 is formed between the third guide surface 83c of the second guide member 83 and the guide surface 86a of the fifth guide member 86.

The reverse transport device 8 includes a transport destination switching member 91, two transport rollers 93, two transport rollers 94, and two transport rollers 95.

The transport destination switching member 91 is a member that switches the transport destination of a sheet 19 that is transported in the ordinary sheet transport path Rt.

The transport destination switching member 91 is driven so as to swing toward two stopping positions with a shaft 92 as a fulcrum, and stops.

The shaft 92 is disposed near a position where the first guide surface 83a and the second guide surface 83b of the second guide member 83 merge with each other.

The two stopping positions are a position where the transport space TA1 is in a blocked state, and a position where the transport space TA2 is in a blocked state (see the state shown by an alternate long and two short dash line in FIG. 10).

When the transport destination switching member 91 swings to the position where the transport space TA1 is in a blocked state, the transport destination of a sheet 19 is switched to the branching-introduction transport space TA2.

When the transport destination switching member 91 swings to the position where the transport space TA2 is in a blocked state, the transport destination of a sheet 19 is switched to the ordinary-transport transport space TA1.

The two transport rollers 93 are lead-in transport rollers. The two transport rollers 93 include a drive roller that rotates in the direction of a dashed arrow, and a driven roller.

The two transport rollers 93 are disposed at predetermined positions at the branching-introduction transport space TA2.

The two transport rollers 94 are lead-in and discharge transport rollers that rotate forwardly and reversely. The two transport rollers 94 include a drive roller that rotates by switching between two directions indicated by a double-headed dashed arrow, and a driven roller.

The two transport rollers 94 are disposed at predetermined positions at the lead-in transport space TA3 and the turnaround-transport transport space TA4.

The two transport rollers 95 are merging transport rollers. The two transport rollers 95 are a drive roller that rotates in the direction of a dashed arrow, and a driven roller.

The two transport rollers 95 are disposed at predetermined positions at the merging transport space TA5.

### Sheet Guide Device

Further, the sheet guide device 6B is disposed in the reverse transport device 8.

As shown in FIG. 11, the sheet guide device 6B includes at least the transport guide sections 81 and auxiliary members 65B.

The sheet guide device 6B of the second exemplary embodiment constitutes a merging branching section where a transport path from the transport space TA2 to the transport space TA3 and a transport path from the transport space TA4 to the transport space TA5 merge and a branching path is formed.

The sheet guide device 6B is disposed such that the auxiliary members 65B join the transport space TA4 and the transport space TA5. The auxiliary members 65B at this time are also disposed in a state to cover a terminal end portion of the transport space TA2.

In the sheet guide device 6B, the second guide member 83 is used as the transport guide section 81.

The sheet guide device 6B is such that the auxiliary members 65B are attached to a lower end portion of the third guide surface 83c of the second guide member 83. The lower end portion of the third guide surface 83c may be provided with an attaching recessed portion for attaching the auxiliary members 65B such that the auxiliary members 65B are flush with the third guide surface 83c.

As shown in FIG. 11, the auxiliary members 65B of the second exemplary embodiment are a first auxiliary member 66 and two second auxiliary members 67A and 67B.

The first auxiliary member 66 is an auxiliary member that is attached to the third guide surface 83c of the second guide member 83 with one of the second auxiliary members, that is, the second auxiliary member 67A being interposed therebetween.

The other structures of the first auxiliary member 66 are the same as the structures of the first auxiliary member 66 of the first exemplary embodiment.

The first auxiliary member 66 is such that a free end 66f on a side opposite to an end portion thereof that is attached to the third guide surface 83c of the second guide member 83 is disposed close to or contacts the vicinity of a lower end of the guide surface 84a of the third guide member 84. The vicinity of the lower end of the guide surface 84a is a portion that is close to a boundary with the bent guide portion 84ac.

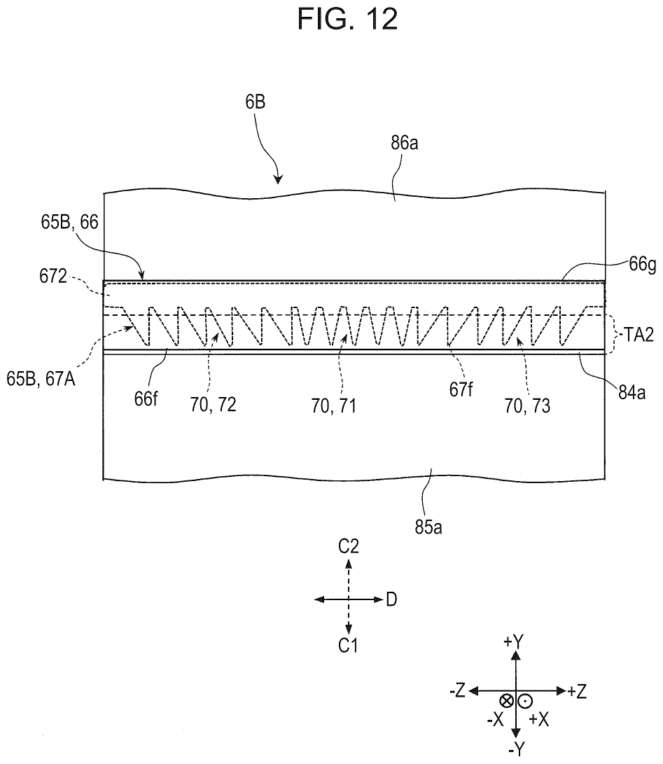

One of the second auxiliary members, that is, the second auxiliary member 67A is an auxiliary member that is attached to the third guide surface 83c of the second guide member 83 and includes narrow-width portions 70. In other words, the second auxiliary member 67A is attached to a surface of the first auxiliary member 66 facing the third guide surface 83c (see FIG. 12). FIG. 12 does not show the second auxiliary member 67B.

The other of the second auxiliary members, that is, the second auxiliary member 67B is an auxiliary member including narrow-width portions 70. The second auxiliary member 67B is attached to a surface of the first auxiliary member 66 on a side opposite to the third guide surface 83c and the second auxiliary member 67A.

The other structures of the second auxiliary members 67A and 67B are the same as the structures of the second auxiliary member 67 of the first exemplary embodiment.

The second auxiliary member 67A is attached such that a lower end 67f thereof is situated at a position slightly displaced on an upward side from the free end 66f of the first auxiliary member 66. The lower end 67f is a portion that becomes an end where the widths of the narrow-width portions 70 become narrowest, and also corresponds to a downstream end of the narrow-width portions 70. The second auxiliary member 67A at this time is attached such that the lower end 67f thereof is close to the vicinity of the lower end of the guide surface 84a of the third guide member 84.

On the other hand, the second auxiliary member 67B is attached such that an upper end 67h thereof is situated at a position slightly displaced on an upward side from the free end 66f of the first auxiliary member 66. The upper end 67h is a portion that becomes an end where the widths of the narrow-width portions 70 become narrowest, and also corresponds to a downstream end of the narrow-width portions 70.

### Operation of Reverse Transport Device and Sheet Guide Device

The reverse transport device 8 guides and transports toward a turnaround stopping position SP, which is a transport destination, a sheet 19 introduced into the branching-introduction transport space TA2.

The sheet 19 at this time is transported in a transport direction C1 by the lead-in transport rollers 93.

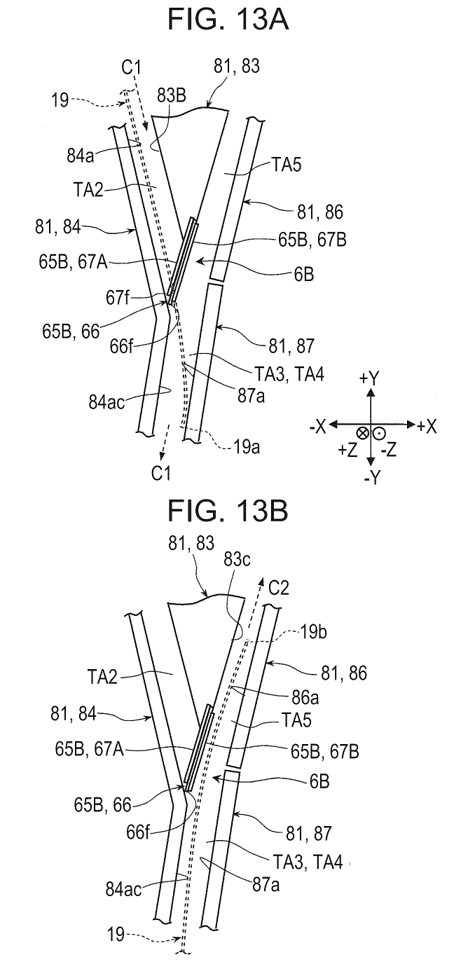

Therefore, the sheet 19 is sent from the transport space TA2 into the lead-in transport space TA3 (see FIG. 13A).

The sheet 19 at this time contacts the auxiliary members 65B of the sheet guide device 6B, moves so as to pass by the auxiliary members 65B, and is guided to the transport space TA3.

Next, the sheet 19 is transferred to the lead-in and discharge transport rollers 94 at the lead-in transport space TA3 by a predetermined amount. That is, the sheet 19 at this time is transported toward the turnaround stopping position SP, which is a transport destination. In addition, the sheet 19 at this time is transported until a back end at the time of the leading-in of the sheet 19 passes through the branching-introduction transport space TA2, and is stopped.

The turnaround stopping position SP is a position where driving of the lead-in and discharge transport rollers 94 is stopped, the transport of the sheet 19 is ended, and the sheet 19 is stopped. The turnaround stopping position SP is set, for example, in a predetermined range in front of and behind and including the transport rollers 94 at the transport space TA3.

The sheet guide device 6B operates as follows when a sheet 19 is transported toward the turnaround stopping position SP.

In the sheet guide device 6B, a portion of the sheet 19 including a front end 19a passes by contacting a portion of the second auxiliary member 67A of the auxiliary members 65B.

Thereafter, at the sheet guide device 6B, the portion of the sheet 19 including the front end 19a passes by contacting a part of the first auxiliary member 66 of the auxiliary members 65B.

The front end 19a of the sheet 19 is a forward end when the sheet 19 is transported in the transport direction C1.

As a result, before the sheet 19 contacts the part of the first auxiliary member 66, the sheet 19 moves by contacting the second auxiliary member 67A including the narrow-width portions 70.

The reverse transport device 8 guides and transports toward the merging transport space TA5, situated at the turnaround position, the sheet 19 that has been transported to the turnaround stopping position SP.

The sheet 19 at this time is transported in a transport direction C2 with its back end 19b being a leading end by the lead-in and discharge transport rollers 94 that rotate in reverse directions.

Therefore, the sheet 19 is sent from the transport space TA4 to the merging transport space TA5 (see FIG. 13B). The back end 19b is an end on a side opposite to the front end 19a.

Next, the sheet 19 is transferred to and transported by the merging transport rollers 95. That is, the sheet 19 at this time has its back end at the time of discharge sent out from the transport rollers 95 and is sent and moved into the ordinary-transport transport space TA1.

By performing the series of operations above, the reverse transport device 8 transports the sheet 19 with its front and back surfaces being reversed so as to move into the ordinary-transport transport space TA1.

The sheet guide device 6B operates as follows when a sheet 19 is transported toward the transport space TA5, situated at the turnaround position.

In the sheet guide device 6B, a portion of the sheet 19 including the back end 19b frequently passes a part of the first auxiliary member 66 of the auxiliary members 65B without contacting the part.

However, the portion of the sheet 19 including the back end 19b may pass the part of the first auxiliary member 66 of the auxiliary members 65B while contacting the part.

Even in this case, before the sheet 19 contacts the part of the first auxiliary member 66, the sheet 19 moves by contacting the second auxiliary member 67B including the narrow-width portions 70.

As a result, before the sheet 19 contacts the part of the first auxiliary member 66, the sheet 19 moves by contacting the second auxiliary member 67B including the narrow-width portions 70.

### Modifications

The present disclosure is not limited to the structural examples exemplified in each of the exemplary embodiments above. In the present disclosure, it is possible to make necessary changes without departing from the spirit of the disclosure as described as means for addressing the problems.

Therefore, the present disclosure includes modifications such as those given below.

The auxiliary members 65 and 65B may be constituted by only auxiliary members including narrow-width portions 70. That is, the auxiliary members 65 and 65B may be constituted by only the second auxiliary members 67 including the narrow-width portions 70 without including the first auxiliary members 66.

This modification is effective when the guide surface 62a to which the auxiliary members 65 are attached or the third guide surface 83c to which the auxiliary members 65B are attached has a physical property of being easily charged.

The narrow-width portions 70 are not limited to those whose planar shapes are triangular shapes. The narrow-width portions 70 may be those whose planar shapes are, for example, trapezoidal shapes or semicircular shapes.

In addition, the multiple narrow-width portions 70 are not limited to three types of narrow-width portions, that is, the narrow-width portions 71 to 73, and may be two types of narrow-width portions or four or more types of narrow-width portions.

Further, the multiple narrow-width portions 70 may be narrow-width portions 70 all having the same planar shapes.

The sheet guide device 6A is not limited to a sheet transport device whose transport destination is the second transfer position TP2, and may be a sheet transport device whose transport destination is a position where another image is to be formed.

The reverse transport device 8 including the sheet guide device 6B can be applied as a part of the sheet transport path of the image forming apparatus 10.

The sheet guide devices 6A and 6B can be applied to a sheet transport path of a side registration transport system. The side registration transport system is a system of transporting a sheet 19 with an end portion of the sheet 19 being aligned with the position of one of end portions of the sheet transport path Rt in the width direction D, the end portion of the sheet 19 being on the same side in the width direction D at the time of transport.

The image forming apparatus 10 using the sheet guide device 6A or the sheet guide device 6B is not particularly limited in terms of, for example, its image forming system or the types of images to be formed.

Therefore, the image forming apparatus 10 may be one whose image forming device uses an image forming system, such as an inkjet system or a printing system, instead of one whose image forming device 20 is an electrophotographic device.

The image forming apparatus 10 is not limited to one that forms images of multiple colors, and may be one that forms images of a single color.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A sheet guide device comprising:
a transport guide section that has a guide surface that, by allowing a sheet that is transported to pass, guides the sheet toward a transport destination; and
an auxiliary member that is chargeable, that is attached to the guide surface, and that assists in guiding the sheet,
wherein the auxiliary member includes a plurality of narrow-width portions existing side by side in a width direction that intersects a transport direction of the sheet and each having a shape whose width becomes narrower in the transport direction.
   (((2)))

The sheet guide device according to (((1))), wherein the plurality of narrow-width portions are such that downstream ends thereof in the transport direction are aligned with respect to each other in the width direction.

(((3)))

The sheet guide device according to (((1))) or (((2))), wherein some narrow-width portions of the plurality of narrow-width portions each have a shape having a linear oblique side that intersects a passage expected position of at least one of two ends, a left end and a right end, of the sheet that is being transported.

(((4)))

The sheet guide device according to (((3))), wherein the narrow-width portions each having the oblique side are such that each of the oblique sides is inclined so as to face a central side in the width direction with respect to the transport direction.

(((5)))

The sheet guide device according to (((3))) or (((4))), wherein the narrow-width portions each having the oblique side each have a shape including a parallel side parallel to the transport direction on a side opposite to the oblique side.

(((6)))

The sheet guide device according to any one of (((3))) to (((5))), wherein a remaining one or remaining ones of the narrow-width portions other than the narrow-width portions each having the oblique side have a planar shape that is an isosceles triangular shape in which the width direction defines a base.

(((7)))

The sheet guide device according to any one of (((3))) to (((6))), wherein the narrow-width portions each having the oblique side are disposed such that the oblique sides exist in a line-symmetry relationship in the width direction.

(((8)))

The sheet guide device according to any one of (((1))) to (((7))), wherein the auxiliary member includes a first auxiliary member that is attached to the guide surface, and a second auxiliary member that is attached on a side of the first auxiliary member opposite to the guide surface and includes the narrow-width portions.

(((9)))

The sheet guide device according to (((8))), wherein the first auxiliary member is attached with a part thereof being in a projecting state from a downstream end of the guide surface in the transport direction, and
wherein the second auxiliary member is attached with downstream ends of the narrow-width portions in the transport direction being displaced upstream in the transport direction with respect to a downstream end of the first auxiliary member in the transport direction.
   (((10)))

The sheet guide device according to (((8))) or (((9))), wherein the second auxiliary member is a member that is less likely to be charged than the first auxiliary member.

(((11)))

The sheet guide device according to any one of (((1))) to (((10))), wherein the auxiliary member is a synthetic resin film or a synthetic resin sheet.

(((12)))

The sheet guide device according to any one of (((1))) to (((11))), wherein when the narrow-width portions are a remaining portion after cutting a part of an original member whose planar shape is a square shape, a plane area of the narrow-width portions is an area that is less than or equal to half a plane area of the original member.

(((13)))

The sheet guide device according to any one of (((1))) to (((12))), wherein the transport destination is a position where an image is formed on the sheet.

(((14)))

The sheet guide device according to any one of (((1))) to (((13))), wherein the transport destination is a turnaround stopping position of the sheet and a turnaround position of the sheet.

(((15)))

An image forming apparatus comprising:
the sheet guide device according to any one of (((1))) to (((14))).

What is claimed is:

1. A sheet guide device comprising:
a transport guide section that has a guide surface that, by allowing a sheet that is transported to pass, guides the sheet toward a transport destination; and
an auxiliary member that is chargeable, that is attached to the guide surface, and that assists in guiding the sheet,
wherein the auxiliary member includes a plurality of narrow-width portions existing side by side in a width direction that intersects a transport direction of the sheet and each having a shape whose width becomes narrower in the transport direction.

2. The sheet guide device according to claim 1, wherein the plurality of narrow-width portions are such that downstream ends thereof in the transport direction are aligned with respect to each other in the width direction.

3. The sheet guide device according to claim 1, wherein some narrow-width portions of the plurality of narrow-width portions each have a shape having a linear oblique side that intersects a passage expected position of at least one of two ends, a left end and a right end, of the sheet that is being transported.

4. The sheet guide device according to claim 3, wherein the narrow-width portions each having the oblique side are such that each of the oblique sides is inclined so as to face a central side in the width direction with respect to the transport direction.

5. The sheet guide device according to claim 3, wherein the narrow-width portions each having the oblique side each have a shape including a parallel side parallel to the transport direction on a side opposite to the oblique side.

6. The sheet guide device according to claim 3, wherein a remaining one or remaining ones of the narrow-width portions other than the narrow-width portions each having the oblique side have a planar shape that is an isosceles triangular shape in which the width direction defines a base.

7. The sheet guide device according to claim 3, wherein the narrow-width portions each having the oblique side are disposed such that the oblique sides exist in a line-symmetry relationship in the width direction.

8. The sheet guide device according to claim 1, wherein the auxiliary member includes a first auxiliary member that is attached to the guide surface, and a second auxiliary member that is attached on a side of the first auxiliary member opposite to the guide surface and includes the narrow-width portions.

9. The sheet guide device according to claim 8, wherein the first auxiliary member is attached with a part thereof being in a projecting state from a downstream end of the guide surface in the transport direction, and
wherein the second auxiliary member is attached with downstream ends of the narrow-width portions in the transport direction being displaced upstream in the transport direction with respect to a downstream end of the first auxiliary member in the transport direction.

10. The sheet guide device according to claim 9, wherein the second auxiliary member is a member that is less likely to be charged than the first auxiliary member.

11. The sheet guide device according to claim 1, wherein the auxiliary member is a synthetic resin film or a synthetic resin sheet.

12. The sheet guide device according to claim 1, wherein when the narrow-width portions are a remaining portion after cutting a part of an original member whose planar shape is a square shape, a plane area of the narrow-width portions is an area that is less than or equal to half a plane area of the original member.

13. The sheet guide device according to claim 1, wherein the transport destination is a position where an image is formed on the sheet.

14. The sheet guide device according to claim 1, wherein the transport destination is a turnaround stopping position of the sheet and a turnaround position of the sheet.

15. An image forming apparatus comprising:
the sheet guide device according to claim 1.

16. An image forming apparatus comprising:
the sheet guide device according to claim 2.

17. An image forming apparatus comprising:
the sheet guide device according to claim 3.

18. An image forming apparatus comprising:
the sheet guide device according to claim 4.

19. An image forming apparatus comprising:
the sheet guide device according to claim 5.

20. An image forming apparatus comprising:
the sheet guide device according to claim 6.
